(19) United States
(12) Patent Application Publication
(10) Pub. No.: US 2004/0039891 A1
(43) Pub. Date: Feb. 26, 2004

(54) Optimizing storage capacity utilization based upon data storage costs

(75) Inventors: Albert Leung, Los Altos, CA (US); Giovanni Paliska, Mountain View, CA (US); Bruce Greenblatt, San Jose, CA (US); Claudia Chandra, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arkivio, Inc., Mountain View, CA

(21) Appl. No.: 10/650,360

(22) Filed: Aug. 27, 2003

Related U.S. Application Data
(63) Continuation-in-part of application No. 10/232,875, filed on Aug. 30, 2002.
(60) Provisional application No. 60/407,587, filed on Aug. 30, 2002.
(60) Provisional application No. 60/407,450, filed on Aug. 30, 2002.
(60) Provisional application No. 60/316,764, filed on Aug. 31, 2001.
(60) Provisional application No. 60/358,915, filed on Feb. 21, 2002.

(51) Int. Cl. G06F 12/00

(52) U.S. Cl. 711/165; 711/114

(57) ABSTRACT

Techniques for optimizing capacity utilization among multiple storage units based upon costs associated with storing data on the storage units. Embodiments of the present invention automatically determine when data movement is needed to optimization storage utilization for a group of storage units. According to an embodiment of the present invention, in order to optimize storage utilization and storage cost, files are moved from a source storage unit to a target storage unit that has a lower data storage cost associated with it than the source storage unit. The storage units may be assigned to one or more servers.

### CROSS-REFERENCES TO RELATED APPLICATIONS

The present application claims priority from and is a non-provisional application of the following provisional applications, the entire contents of which are herein incorporated by reference for all purposes:

(1) U.S. Provisional Application No. 60/407,587, filed Aug. 30, 2002 (Attorney Docket No. 21154-5US); and

(2) U.S. Provisional Application No. 60/407,450, filed Aug. 30, 2002 (Attorney Docket No. 21154-8US).

The present application also claims priority from and is a continuation-in-part (CIP) application of U.S. Non-Provisional application Ser. No. 10/232,875, filed Aug. 30, 2002 (Attorney Docket No. 21154-000210US), which in turn is a non-provisional of U.S. Provisional Application No. 60/316,764, filed Aug. 31, 2001, (Attorney Docket No. 21154-000200US) and U.S. Provisional Application No. 60/358,915, filed Feb. 21, 2002 (Attorney Docket No. 21154-000400US). The entire contents of the aforementioned applications are herein incorporated by reference for all purposes.

The present application also incorporates by reference for all purposes the entire contents of U.S. Non-Provisional Application No. ______, filed concurrently with this application (Attorney Docket No. 21154-000810US).

### BACKGROUND OF THE INVENTION

The present invention relates generally to management of storage environments and more particularly to techniques for automatically optimizing storage capacity utilization among multiple storage units in a storage environment based upon data storage costs associated with the storage units.

In a typical storage environment comprising multiple servers coupled to one or more storage units (either physical storage units or logical storage units such as volumes), an administrator administering the environment has to perform several tasks to ensure availability and efficient accessibility of data. In particular, an administrator has to ensure that there are no outages due to lack of availability of storage space on any server, especially servers running critical applications. The administrator thus has to monitor space utilization on the various servers. Presently, this is done either manually or using software tools that generate alarms/alerts when certain capacity thresholds associated with the storage units are reached or exceeded. In the manual approach, when an overcapacity condition is detected, the administrator has to manually move data from a storage unit experiencing the overcapacity condition to another storage unit that has sufficient space for storing the data without exceeding the capacity threshold for that server. This task can be very time consuming, especially in a storage environment comprising a large number of servers and storage units.

Additionally, a change in location of data from one location to another impacts existing applications, users, and consumers of the data. In order to minimize this impact, the administrator has to make adjustments to existing applications to update the data location information (e.g., the location of the database, mailbox, etc). The administrator also has to inform users about the new location of moved data. Accordingly, many of the conventional storage management operations and procedures are not transparent to data consumers.

More recently, several tools and applications are available that attempt to automate some of the manual functions performed by the administrator. For example, Hierarchical Storage Management (HSM) applications are used to migrate data among a hierarchy of storage devices. For example, files may be migrated from online storage to near-online storage and from near-online storage to offline storage to manage storage utilization. When a file is migrated from its original storage location to a target storage location, a stub file or tag file is left in place of migrated file on the original storage location. The stub file occupies less storage space than the migrated file and generally comprises metadata related to the migrated file. The stub file may also comprise information that can be used to determine the target location of the migrated file. A migrated file may be remigrated to another destination storage location.

In a HSM application, an administrator can set up rules/policies for migrating the files from expensive storage forms to less expensive forms of storage. While HSM applications eliminate some of the manual tasks that were previously performed by the administrator, the administrator still has to specifically identify the data (e.g., the file(s)) to be migrated, the storage unit from which to migrate the files (referred to as the “source storage unit”), and the storage unit to which the files are to be migrated (referred to as the “target storage unit”). As a result, the task of defining HSM policies can become quite complex and cumbersome in storage environments comprising a large number of storage units. The problem is further aggravated in storage environments in which storage units are continually being added or removed.

Another disadvantage of applications such as HSM is that the storage policies have to be defined on a per server basis. Accordingly, in a storage environment comprised of multiple servers, the administrator has to specify storage policies for each of the servers. This can also become quite cumbersome in storage environments comprising a large number of servers. Accordingly, even though storage management applications such as HSM applications reduce some of the manual tasks that were previously performed by administrators, they are still limited in their applicability and convenience.

### BRIEF SUMMARY OF THE INVENTION

Embodiments of the present invention provide techniques for optimizing capacity utilization among multiple storage units based upon costs associated with storing data on the storage units. Embodiments of the present invention automatically determine when data movement is needed to optimize storage utilization for a group of storage units. According to an embodiment of the present invention, in order to optimize overall storage utilization and storage cost, files are moved from a source storage unit to a target storage unit that has a lower data storage cost associated with it than the source storage unit. The storage units may be assigned to one or more servers.

According to an embodiment of the present invention, techniques are provided for managing a storage environment comprising a plurality of storage units. In this embodiment, a condition associated with a first storage unit from the plurality of storage units is detected. A first group is determined from a plurality of groups to which the first storage unit belongs, wherein each group comprises one or more storage units from the plurality of storage units and inclusion of a storage unit in a group depends on a cost of storing data on the storage unit. A second group from the plurality of groups is identified having an associated data storage cost that is lower than a data storage cost associated with the first group. A file stored on the first storage unit to be moved is identified. A storage unit from the second group for storing the file is identified. The identified file is moved from the first storage unit to the storage unit from the second group that has been identified for storing the file.

According to another embodiment of the present invention, techniques are provided for managing a storage environment comprising a plurality of storage units. In this embodiment, a condition associated with a first storage unit from the plurality of storage units is detected. A file stored on the first storage unit to be moved is identified. A storage unit from the plurality of storage units is identified for storing the identified file, wherein the data storage cost associated with identified storage unit is lower than a data storage cost associated with the first storage unit. The identified file is moved from the first storage unit to the storage unit from the second group that has been identified for storing the file.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of a storage environment that may incorporate an embodiment of the present invention;

FIG. 2 is a simplified block diagram of storage management system (SMS) according to an embodiment of the present invention;

FIG. 3 depicts three managed groups according to an embodiment of the present invention;

FIG. 4 is a simplified high-level flowchart depicting a method of optimizing storage capacity utilization and data storage costs according to an embodiment of the present invention;

FIG. 5 depicts another flowchart depicting another method of optimizing capacity utilization based upon data storage costs associated with storage units according to an embodiment of the present invention;

FIG. 6 is a simplified flowchart depicting a method of selecting a file for a move or migration operation according to an embodiment o the present invention;

FIG. 7 is a simplified flowchart depicting a method of selecting a file for a move or migration operation according to an embodiment of the present invention wherein multiple placement rules are configured;

FIG. 8 is a simplified flowchart depicting a method of selecting a target volume from a set of volumes according to an embodiment of the present invention;

FIG. 9 is a simplified block diagram showing modules that may be used to implement an embodiment of the present invention; and

FIG. 10 depicts examples of placement rules according to an embodiment of the present invention.

### DETAILED DESCRIPTION OF THE INVENTION

In the following description, for the purposes of explanation, specific details are set forth in order to provide a thorough understanding of the invention. However, it will be apparent that the invention may be practiced without these specific details.

For purposes of this application, migration of a file involves moving the file (or a data portion of the file) from its original storage location on a source storage unit to a target storage unit. A stub or tag file may be stored on the source storage unit in place of the migrated file. The stub file occupies less storage space than the migrated file and generally comprises metadata related to the migrated file. The stub file may also comprise information that can be used to determine the target storage location of the migrated file. When a user or application accesses a stub on a source storage unit, a recall operation is performed. The recall transparently restores the migrated (or remigrated) file to its original storage location on the source storage unit for the user or application to access.

For purposes of this application, remigration of a file involves moving a previously migrated file from its present storage location to another storage location. The stub file information or information stored in a database corresponding to the remigrated file may be updated to reflect the storage location to which the file is remigrated.

For purposes of this application, unless specified otherwise, moving a file from a source storage unit to a target storage unit is intended to include migrating the file from the source storage unit to the target storage unit, or remigrating a file from the source storage unit to the target storage unit, or simply changing the location of a file from one storage location to another storage location. Movement of a file may have varying levels of impact on the end user. For example, in case of migration and remigration operations, the movement of a file is transparent to the end user. The use of techniques such as symbolic links in UNIX, Windows shortcuts may make the move somewhat transparent to the end user. The move may also be accomplished without leaving any links, shortcuts, or stub/tag files, which may impact the way the end user accesses the file.

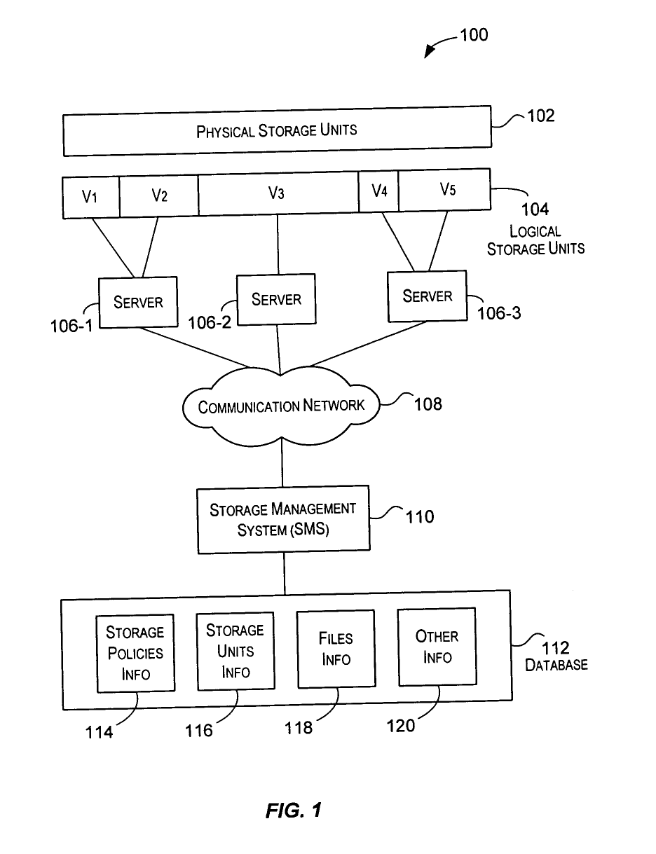

FIG. 1 is a simplified block diagram of a storage environment 100 that may incorporate an embodiment of the present invention. Storage environment 100 depicted in FIG. 1 is merely illustrative of an embodiment incorporating the present invention and does not limit the scope of the invention as recited in the claims. One of ordinary skill in the art would recognize other variations, modifications, and alternatives.

As depicted in FIG. 1, storage environment 100 comprises a plurality of physical storage devices 102 for storing data. Physical storage devices 102 may include disk drives, tapes, hard drives, optical disks, RAID storage structures, solid state storage devices, SAN storage devices, NAS storage devices, and other types of devices and storage media capable of storing data. The term “physical storage unit” is intended to refer to any physical device, system, etc. that is capable of storing information or data.

Physical storage units 102 may be organized into one or more logical storage units (or logical devices) 104 that provide a logical view of underlying disks provided by physical storage units 102. Each logical storage unit (e.g., a volume) is generally identifiable by a unique identifier (e.g., a number, name, etc.) that may be specified by the administrator. A single physical storage unit may be divided into several separately identifiable logical storage units. A single logical storage unit may span storage space provided by multiple physical storage units 102. A logical storage unit may reside on non-contiguous physical partitions. By using logical storage units, the physical storage units and the distribution of data across the physical storage units becomes transparent to servers and applications. For purposes of description and as depicted in FIG. 1, logical storage units 104 are considered to be in the form of volumes. However, other types of storage units including physical storage units and logical storage units are also within the scope of the present invention.

Storage environment 100 also comprises several servers 106. Server 106 may be data processing systems that are configured to provide a service. Each server 106 may be assigned one or more volumes from logical storage units 104. For example, as depicted in FIG. 1, volumes V1 and V2 are assigned to server 106-1, volume V3 is assigned to server 106-2, and volumes V4 and V5 are assigned to server 106-3. A server 106 provides an access point for the one or more volumes assigned to that server. Servers 106 may be coupled to a communication network 108.

In FIG. 1, a storage management system/server (SMS) 110 is coupled to server 106 via communication network 108. Communication network 108 provides a mechanism for allowing communication between SMS 110 and servers 106. Communication network 108 may be a local area network (LAN), a wide area network (WAN), a wireless network, an Intranet, the Internet, a private network, a public network, a switched network, or any other suitable communication network. Communication network 108 may comprise many interconnected computer systems and communication links. The communication links may be hardwire links, optical links, satellite or other wireless communications links, wave propagation links, or any other mechanisms for communication of information. Various communication protocols may be used to facilitate communication of information via the communication links, including TCP/IP, HTTP protocols, extensible markup language (XML), wireless application protocol (WAP), Fiber Channel protocols, protocols under development by industry standard organizations, vendor-specific protocols, customized protocols, and others.

SMS 110 is configured to provide storage management services for storage environment 100 according to an embodiment of the present invention. These management services include performing automated capacity management and data movement between the various storage units in the storage environment 100. The term “storage unit” is intended to refer to a physical storage unit (e.g., a disk) or a logical storage unit (e.g., a volume). According to an embodiment of the present invention, SMS 110 is configured to monitor and gather information related to the capacity usage of the storage units in the storage environment and to perform capacity management (including managing capacity based upon data storage costs) and data movement based upon the gathered information. SMS 110 may perform monitoring in the background to determine the instantaneous state of each of the storage units in the storage environment. SMS 110 may also monitor the file system in order to collect information about the files such as file size information, access time information, file type information, etc. The monitoring may also be performed using agents installed on the various servers 106 for monitoring the storage units assigned to the servers and the file system. The information collected by the agents may be forwarded to SMS 110 for processing according to the teachings of the present invention.

The information collected by SMS 110 may be stored in a memory or disk location accessible to SMS 110. For example, as depicted in FIG. 1, the information may be stored in a database 112 accessible to SMS 110. The information stored in database 112 may include information 114 related to storage policies and rules configured for the storage environment, information 116 related to the various monitored storage units, information 118 related to the files stored in the storage environment, and other types of information 120. Various formats may be used for storing the information. As described below, the stored information may be used to perform capacity management based upon data storage costs according to an embodiment of the present invention.

Information 116 related to the storage units may include information related to the cost of storing data on the storage units. For purposes of this application, for a storage unit the cost of storing data on that storage unit will be referred to as the “data storage cost” associated with the storage unit. The data storage cost for a storage unit may be provided by the manufacturer of the storage unit. The data storage cost for a storage unit may also be assigned by an administrator of the storage environment or by a user of the storage environment.

The data storage cost for a storage unit may be expressed in various forms. According to one form, the storage cost may be expressed as a monetary value of storing data per unit of storage, for example, dollars-per-Gigabyte of storage. For example, the data storage cost for a first storage unit may be $1-per-GB, for a second storage unit may be $2-per-GB, for a third storage unit may be $5-per-GB, and the like. The data storage cost for an storage unit may also be expressed in the form of a label or category or classification, such as “low cost”, “high cost”, “medium cost”, “expensive”, “cheap”, etc. These labels/classifications/categories are generally assigned by a system administrator. According to the teachings of the present invention, the data storage costs associated with storage units may be used to classify the storage units into one or more groups.

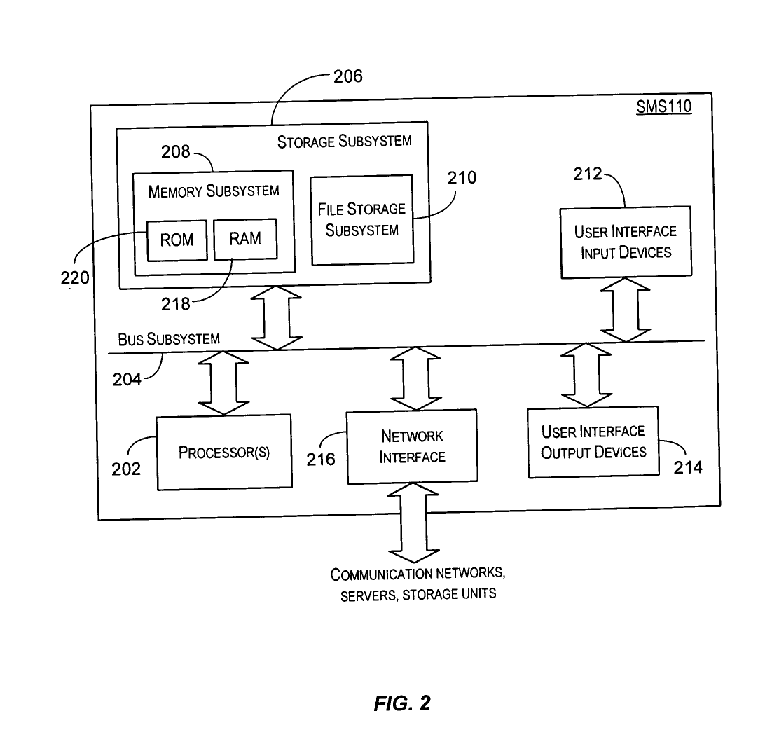

FIG. 2 is a simplified block diagram of SMS 110 according to an embodiment of the present invention. As shown in FIG. 2, SMS 110 includes a processor 202 that communicates with a number of peripheral devices via a bus subsystem 204. These peripheral devices may include a storage subsystem 206, comprising a memory subsystem 208 and a file storage subsystem 210, user interface input devices 212, user interface output devices 214, and a network interface subsystem 216. The input and output devices allow a user, such as the administrator, to interact with SMS 110.

Network interface subsystem 216 provides an interface to other computer systems, networks, servers, and storage units. Network interface subsystem 216 serves as an interface for receiving data from other sources and for transmitting data to other sources from SMS 110. Embodiments of network interface subsystem 216 include an Ethernet card, a modem (telephone, satellite, cable, ISDN, etc.), (asynchronous) digital subscriber line (DSL) units, and the like.

User interface input devices 212 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to SMS 110.

User interface output devices 214 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from SMS 110.

Storage subsystem 206 may be configured to store the basic programming and data constructs that provide the functionality of the present invention. For example, according to an embodiment of the present invention, software code modules implementing the functionality of the present invention may be stored in storage subsystem 206. These software modules may be executed by processor(s) 202. Storage subsystem 206 may also provide a repository for storing data used in accordance with the present invention. For example, the information gathered by SMS 110 may be stored in storage subsystem 206. Storage subsystem 206 may also be used as a migration repository to store data that is moved from another storage unit. Storage subsystem 206 may also be used to store data that is moved from another storage unit. Storage subsystem 206 may comprise memory subsystem 208 and file/disk storage subsystem 210.

Memory subsystem 208 may include a number of memories including a main random access memory (RAM) 218 for storage of instructions and data during program execution and a read only memory (ROM) 220 in which fixed instructions are stored. File storage subsystem 210 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Bus subsystem 204 provides a mechanism for letting the various components and subsystems of SMS 110 communicate with each other as intended. Although bus subsystem 204 is shown schematically as a single bus, alternative embodiments of the bus subsystem may utilize multiple busses.

SMS 110 can be of various types including a personal computer, a portable computer, a workstation, a network computer, a mainframe, a kiosk, or any other data processing system. Due to the ever-changing nature of computers and networks, the description of SMS 110 depicted in FIG. 2 is intended only as a specific example for purposes of illustrating the preferred embodiment of the computer system. Many other configurations having more or fewer components than the system depicted in FIG. 2 are possible.

Embodiments of the present invention perform automated capacity management and data movement between multiple storage units based upon costs associated with storing data on the storage units. The operation generally involves moving one or more files from a storage unit (referred to as the “source storage unit”) to one or more other storage units (referred to as “target storage units”). As described above in the “Background” section, in conventional HSM-type applications, in order to perform data movement, the administrator has to explicitly specify the file(s) to be moved, the source storage unit, and the target storage unit to which the files are to be moved. According to embodiments of the present invention, the administrator does not have to explicitly specify the file to be moved, the source storage unit, or the target storage unit. The administrator may only specify the data storage costs associated with the storage units and data movement is automatically performed between the storage units such that total utilized storage costs are minimized. The administrator may only specify groups of storage units to be managed (referred to as the “managed groups”) and the data storage costs associated with each managed group of storage units. Embodiments of the present invention are then able to automatically move data between the managed groups such that overall utilized storage costs are minimized. Embodiments of the present invention are also able to automatically determine when data movement is to be performed, determine a source storage unit, files to be moved, and one or more target storage units to which the selected file(s) are to be moved.

According to an embodiment of the present invention, each managed group can include one or more storage units. The storage units in a managed group may be assigned or coupled to one server or to multiple servers. A particular storage unit can be a part of multiple managed groups. Multiple managed groups may be defined for a storage environment.

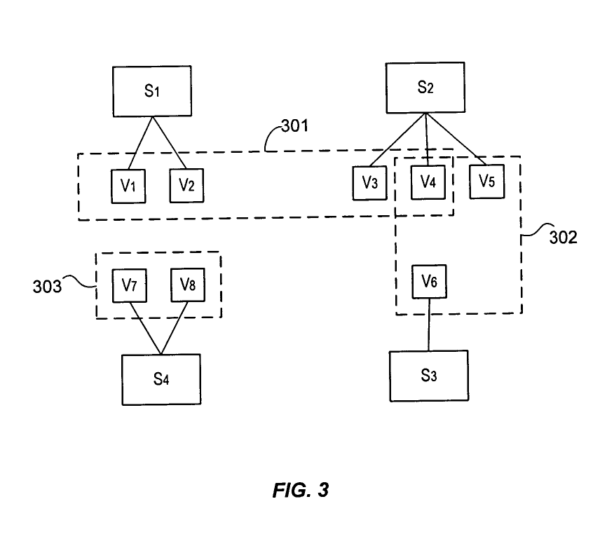

FIG. 3 depicts three managed groups according to an embodiment of the present invention. The first managed group 301 includes four volumes, namely, V1, V2, V3, and V4. Volumes V1 and V2 are assigned to server S1 and volumes V3 and V4 are assigned to server S2. Accordingly, managed group 301 comprises volumes assigned to multiple servers. The second managed group 302 includes three volumes, namely, V4 and V5 assigned to server S2, and V6 assigned to server S3. Volume V4 is part of managed groups 301 and 302. Managed group 303 includes volumes V7 and V8 assigned to server S4. Various other managed groups may also be specified.

According to an embodiment of the present invention, storage units are assigned or allocated to one or more managed groups based upon data storage costs associated with the storage units. As previously described, information identifying data storage costs for the storage units in a storage environment may be stored (e.g., stored as part of storage unit information 116 depicted in FIG. 1). In one embodiment, this cost information is analyzed and managed groups are automatically formed based upon the analysis. In this embodiment, storage units with data storage costs that fall within a certain cost range may be classified into one managed group, storage units with data storage costs that fall within another range may be classified into another managed group, and the like. Alternatively, all storage units having data storage costs above a user-configurable threshold value may be organized into one managed group and the other storage units may be organized into another managed group. For example, storage units in a storage environment may be classified into two managed groups: a “high cost” managed group comprising storage units whose data storage cost is above a user-configurable threshold value, and a “low cost” managed group comprising storage units whose data storage cost is below the user-configurable threshold value. For example, the user-configurable threshold may set at $4 per GB.

The storage environment administrator may also pick and select storage units to be included in a managed group and assign a data storage cost for the managed group. For example, a user interface may be displayed on SMS 100 that displays a list of storage units in the storage environment that are available for selection and the data storage costs associated with the storage units. A user may then form managed groups by selecting one or more of the displayed storage units and assign data storage value to the managed groups.

Managed groups based upon storage costs may also be automatically formed based upon storage data cost-related criteria specified by the administrator. According to this technique, an administrator may define cost criteria for a managed group and a storage unit is included in the managed group if it satisfies the cost criteria specified for that managed group.

Multiple managed groups, each comprising one or more storage units, may thus be defined for a storage environment based upon data storage costs associated with the storage units. A data storage cost may be associated with each managed group based upon the cost criteria used for forming the group. The data storage cost for a managed group may be expressed as a dollar-per-GB, a category/label/classification (e.g., “high cost” group, “low cost” group, etc.), etc.

The managed groups in a storage environment may be ranked relative to each other based upon the data storage costs associated with groups. For example, if two managed groups have been defined based upon data storage costs, one group may be classified as the “high cost” group (or “greater than $4-per-GB” group) while the other group may be classified as the “low cost group” (or “less than $4-per-GB” group). If three groups have been configured, a first group may be classified as the “high cost” group, a second group may be classified as the “medium cost” group, and a third group may be classified as the “low cost group”. Given a particular managed group, the ranking information is useful for determining groups that have greater data storage costs than the particular managed group and groups that have lower data storage costs than the particular managed group.

It should be noted that in addition to data storage cost related criteria, other criteria related to other attributes of the storage units may also be used for forming managed groups. The other criteria may include a criterion related to volume capacity, a criterion related to the manufacturer of the storage device, a criterion related to device type (e.g., SCSI, Fibre Channel, IDE, NAS, etc.), and the like. However, for purposes of this application the managed groups refer to groups that are formed based upon data storage costs associated with the storage units and possibly other criteria. Accordingly, a storage unit is included in a particular managed group if the storage unit matches the cost criteria (and other specified criteria) specified for that particular managed group. A managed group based upon data storage costs may also include one or more other managed groups configured using other criteria.

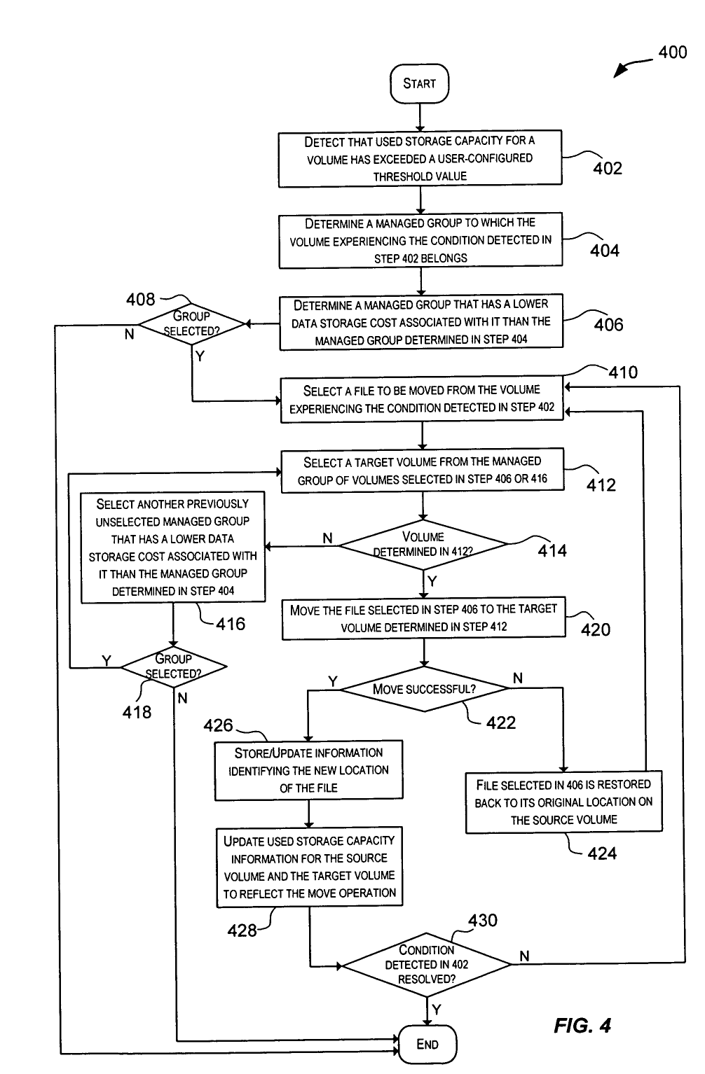

For each managed group, embodiments of the present invention automatically perform storage optimization for the storage units in the managed groups based upon the data storage costs associated with the storage units. FIG. 4 is a simplified high-level flowchart 400 depicting a method of optimizing storage capacity utilization and data storage costs according to an embodiment of the present invention. The method depicted in FIG. 4 may be performed by software modules executed by a processor, hardware modules, or combinations thereof. According to an embodiment of the present invention, the processing is performed by a policy management engine (PME) executing on SMS 110. Flowchart 400 depicted in FIG. 4 is merely illustrative of an embodiment of the present invention and is not intended to limit the scope of the present invention. Other variations, modifications, and alternatives are also within the scope of the present invention. For sake of description, the processing depicted in FIG. 4 assumes that the storage units are in the form of volumes. It should be apparent that the processing can also be applied to other types of storage units.

As depicted in FIG. 4, processing is initiated upon detecting that used storage capacity for a volume in the storage environment has exceeded a user-configured threshold value (or alternatively, the available storage capacity of a volume in the storage environment has fallen below a user-configured threshold value) (step 402). The used storage capacity is the amount of the storage unit that is used or occupied. The available storage capacity is the portion of a storage unit that is available for storing data. As previously indicated, according to an embodiment of the present invention depicted in FIG. 1, SMS 110 is configured to monitor and gather information related to the utilization of the storage units in the storage environment. SMS 110 may perform the monitoring in the background to determine the instantaneous state of each of the storage units in the storage environment. The monitoring may also be performed using agents installed on the various servers 106 for monitoring the storage units assigned to the servers and the file system. Accordingly, the condition that is detected in step 402 may be detected by SMS 110. The condition may also be detected by other systems, devices, or application programs. The volume that is experiencing the condition detected in step 402 is referred to as the “source volume” or “source storage unit” as it represents a volume or storage unit from which data is to be moved in order to resolve the detected overcapacity condition.

The managed group to which the volume experiencing the condition detected in step 402 belongs is then determined (step 404). A “target” managed group is then determined that has a lower data storage cost associated with it than the managed group determined in step 404 (step 406). As indicated above, the managed groups may be ranked relative to each other based upon the storage data costs information associated with the groups. This ranking information may be used to determine the managed group in step 406. For example, if a “high cost” managed group and a “low cost” managed group have been defined for a storage environment, and it is determined in step 404 that the volume experiencing an overcapacity condition belongs to the “high cost” managed group, then in step 406 the “low cost” managed group is selected. As another example, if a “high cost” managed group, a “medium cost” managed group, and a “low cost” managed group have been defined for a storage environment, and it is determined in step 404 that the volume experiencing an overcapacity condition belongs to the “high cost” managed group, then in step 406 either the “low cost” managed group or the “medium cost” managed group may be selected.

A check is then made to determine if a target managed group was selected in step 406 (step 408). If no group was selected, it indicates that there is no other managed group in the storage environment with a data storage cost that is lower than the data storage cost associated with the managed group determined in step 404. In this case the processing is terminated. After termination, the managed groups of volumes continue to be monitored for the next condition that triggers the processing depicted in FIG. 4. If it is determined in step 408 that a managed group with a lower data storage cost associated with it was identified in step 406, then processing continues with step 410.

A file is then selected to be moved from the volume experiencing the condition detected in step 402 (step 410). Various techniques may be used for selecting the file to be moved from the source volume. According to one technique, the largest file stored on the source volume is selected. According to another technique, the least recently accessed file may be selected to be moved. Other file attributes such as age of the file, type of the file, etc. may also be used to select a file to be moved.

According to an embodiment of the present invention, the techniques described in U.S. patent application Ser. No. 10/232,875 filed Aug. 30, 2002 (Attorney Docket No. 21154-000210US) and techniques described below may be used to select the file to be moved from the source volume. According to these techniques, a data value score (DVS) is generated for the files stored on the source volume, and the file with the highest DVS is selected in step 410 for the move operation. Further description related to the use of DVSs for selecting files to be moved is discussed below.

A volume to which the file selected in step 410 is to be moved is then selected from the target managed group of volumes determined in step 406 or step 416 (step 412). The volume (or storage unit in general) identified in step 412 is referred to as a “target volume” or “target storage unit” as it represents a storage unit to which data will be moved. The target volume selected in step 412 and the source volume may be assigned to the same or different servers.

Various techniques may be used for selecting the target volume in step 412. According to one embodiment, the least full volume from the managed group of volumes determined in step 406 (or 416) is selected as the target volume. According to another embodiment of the present invention, the administrator may specify criteria for selecting a target, and a volume that satisfies the criteria is selected as the target volume. According to yet another embodiment, techniques described in U.S. patent application Ser. No. 10/232,875 filed Aug. 30, 2002 (Attorney Docket No. 21154-000210US), and techniques described below may be used to select a target volume in step 410. In this embodiment, a storage value score (SVS) (also referred to as the “relative storage valued score” or RSVS) is generated for the various volumes included in the managed group of volumes determined in step 406 or 416. A volume with the highest SVS is then selected as the target volume from among the volumes in the managed group. Further details related to generation of SVSs and uses of the SVSs to select a target volume are given below.

A check is then made to determine if a volume was selected in step 412 (step 414). If no volume could be determined in step 412, then another previously unselected target managed group that has less data storage costs associated with it than the managed group of the source volume (i.e., the managed group determined in step 404) is selected (step 416). A check is then made to determine if a target managed group was selected in step 416 (step 418). If no group was selected it implies that there is no other target managed group with a data storage cost associated with it that is lower than the data storage cost of the managed group determined in step 404. In this case the processing depicted in FIG. 4 is terminated. Upon termination, the managed groups of volumes continue to be monitored for the next condition that triggers the processing depicted in FIG. 4.

If it is determined in step 414 that a target managed group with a lower data storage cost associated with it was identified in step 412, then processing continues with step 422. The file selected in step 410 is then moved from the source volume to the target volume selected in step 412 (step 420). A check is then made to determine if the move operation was successful (step 422). If the move operation was unsuccessful, then the file selected in step 410 is restored back to it original location on the source volume (step 424). Processing then continues with step 410 and another file from the source volume is selected to be moved.

If the move operation in step 420 was successful, then information identifying the new location of the file on the target volume is stored and/or updated (step 426). According to an embodiment of the present invention, if there is any stub file associated with the moved file, then the stub file information (or information stored in a database) may be updated to reflect the new location of the file on the target volume. In an alternative embodiment, other information may be left in the original location in the form of UNIX symbolic links, Window shortcuts, etc., or the administrator may need to inform users if the operation is to simply move (not migrate) the file. The information may also be stored or updated in a storage location (e.g., a database) accessible to SMS 110.

The used storage capacity information for the source volume and the target volume to which the file is moved is updated to reflect the file move (step 428).

A check is then made to see if the condition detected in step 402 that triggered the processing depicted in FIG. 4 has been resolved (step 430). For example, if the condition in step 402 was an overcapacity condition, a check is made in step 430 to determine if the overcapacity condition for the source volume has been resolved. If it is determined in step 430 that the condition has been resolved, then processing terminates for the condition detected in step 402. The volumes in the storage environment then continue to be monitored for the next condition that triggers the processing depicted in FIG. 4.

If it is determined in step 430 that the condition detected in step 402 has not been resolved, then processing continues with step 410 wherein another file is selected to be moved from the source volume. Alternatively, processing may continue to select another source volume from the managed group determined in step 404. During the processing, the target volume selected in step 412 may be the same as or different from the previously selected target volume. The steps depicted in FIG. 4 are then repeated as described above.

As described above, embodiments of the present invention provide the ability to automatically detect when an overcapacity condition (e.g., when the used storage capacity for a volume exceeds a user-configured threshold value) has been reached for a volume. A target volume is then automatically and dynamically determined for receiving files from the source volume to resolve the overcapacity condition of the source volume. The target volume is selected from a managed group that has a lower data storage cost associated with it than the managed group of the source volume. Accordingly, data is moved from a source volume to a target volume that has a lower storage data cost associated with it.

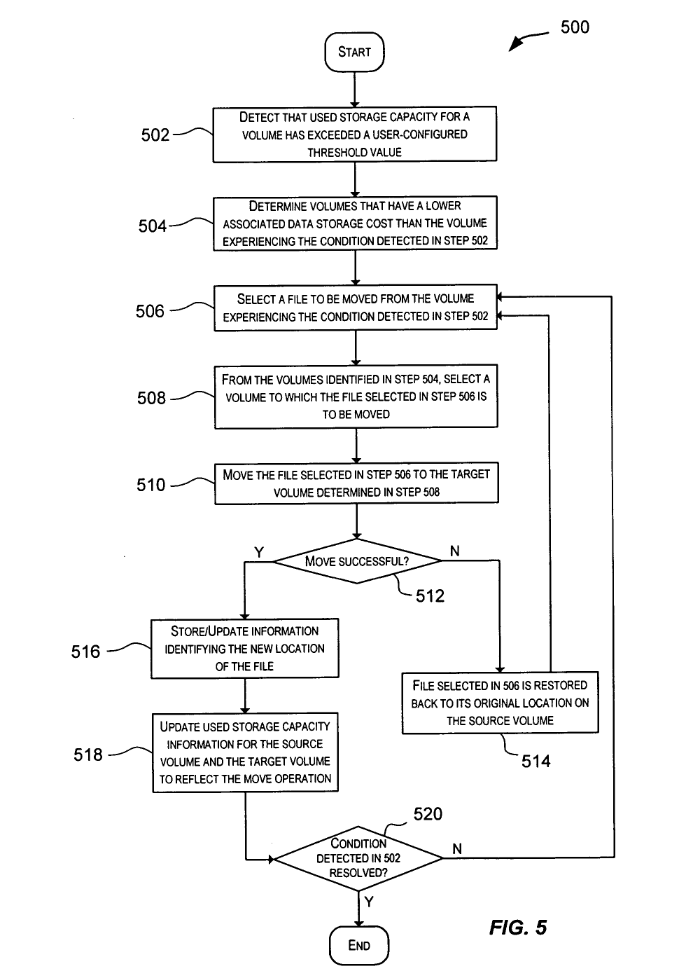

FIG. 5 depicts another flowchart 500 depicting another method of optimizing capacity utilization based upon data storage costs associated with storage units according to an embodiment of the present invention. Flowchart 500 depicted in FIG. 5 is merely illustrative of an embodiment of the present invention and is not intended to limit the scope of the present invention. Other variations, modifications, and alternatives are also within the scope of the present invention. For sake of description, the processing depicted in FIG. 5 assumes that the storage units are in the form of volumes. It should be apparent that the processing can also be applied to other types of storage units.

As depicted in FIG. 5, processing is initiated upon detecting that used storage capacity for a volume has exceeded a user-configured threshold value (or alternatively, the available storage capacity of a volume in the storage environment has fallen below a user-configured threshold value) (step 502). The condition may be detected using any of the techniques described above. The volume that is experiencing the condition detected in step 502 is referred to as the “source volume” or “source storage unit” as it represents a volume or storage unit from which data is to be moved in order to resolve the detected overcapacity condition.

As part of step 502, the extent of the overcapacity for the source volume may also be determined. This may be determined by calculating the difference between the used storage capacity of the source volume and the user-configured threshold capacity value (e.g., extent of overcapacity=(used storage capacity of source volume)−(user-configured capacity threshold)).

Volumes in the storage environment that have an associated data storage cost that is lower than the data storage cost associated with the volume experiencing the overcapacity condition detected in step 502 and that are available for storing data are then determined (step 504).

A file to be moved from the source volume is then selected (step 506). Various techniques may be used for selecting the file to be moved from the source volume. According to one technique, the largest file stored on the source volume is selected. According to another technique, the least recently accessed file may be selected to be moved. Other file attributes such as age of the file, type of the file, etc. may also be used to select a file to be moved.

According to an embodiment of the present invention, the techniques described in U.S. patent application Ser. No. 10/232,875 filed Aug. 30, 2002 (Attorney Docket No. 21154-000210US), and described below, may be used to select the file to be moved from the source volume. According to these techniques, a data value score (DVS) score is generated for the files stored on the source volume, and the file with the highest DVS is selected in step 506 for the move operation. Further description related to the use of DVSs for selecting files to be moved is discussed below.

From the volumes determined in step 504, a volume is selected for storing the file selected in step 506 (step 508). The volume (or storage unit in general) identified in step 508 is referred to as a “target volume” or “target storage unit” as it represents a storage unit to which data will be moved. The target volume selected in step 508 and the source volume may be assigned to the same or different servers.

Various techniques may be used for selecting the target volume in step 508. According to one embodiment, the least full volume from the volumes determined in step 504 is selected as the target volume in step 508. According to another embodiment, the volume with the lowest data storage cost associated with it is selected as the target volume in step 508. According to another embodiment, the administrator may specify criteria for selecting the target volume, and a volume from the volumes determined in step 504 that satisfies the criteria is selected as the target volume.

According to yet another embodiment, techniques described in U.S. patent application Ser. No. 10/232,875 filed Aug. 30, 2002 (Attorney Docket No. 21154-000210US), and described below, may be used to select a target volume in step 410. In this embodiment, a storage value score (SVS) (also referred to as the “relative storage valued score” or RSVS) is generated for the various volumes determined in step 504. A volume with the highest SVS is then selected as the target volume. Further details related generation of SVSs and use of SVSs to select a target volume are given below.

The file selected in step 506 is then moved from the source volume to the target volume selected in step 508 (step 510). A check is then made to determine if the move operation was successful (step 512). If the move operation was unsuccessful, then the file selected in step 506 is restored back to it original location on the source volume (step 514). Processing then continues with step 506 wherein another file from the source volume is selected to be moved.

If the move operation in step 510 was successful, then information identifying the new location of the file on the target volume is stored and/or updated (step 516). According to an embodiment of the present invention, if there is any stub file associated with the moved file, then the stub file information (or information stored in a database) may be updated to reflect the new location of the file on the target volume. In an alternative embodiment, other information may be left in the original location in the form of UNIX symbolic links or Window shortcuts, or the administrator may have to inform the user of the new location if the operation is to move (and not migrate) the data. The information may also be stored or updated in a storage location (e.g., a database) accessible to SMS 110.

The used storage capacity information for the source volume from which the file is moved and the target volume to which the file is moved is updated to reflect the file move (step 518).

A check is then made to see if the overcapacity condition detected in step 502 that triggered the processing depicted in FIG. 5 has been resolved (step 520). The processing depicted in FIG. 5 terminates if it is determined that the condition detected in step 502 has been resolved. The volumes in the storage environment continue to be monitored for the next condition that triggers the processing depicted in FIG. 5.

If it is determined in step 520 that the condition detected in step 502 has not been resolved, then processing continues with step 506 wherein another file from the source volume is selected to be moved. The steps in FIG. 5 are then repeated as described above. For each pass through the flowchart, the target volume selected in step 508 may be the same as or different from the previously selected target volume.

As described above, embodiments of the present invention provide the ability to automatically detect when an overcapacity condition (e.g., when the used storage capacity for a volume exceeds a user-configured threshold value) has been reached for a volume. A target volume that has a lower storage data cost than the source volume is then automatically and dynamically determined for moving files from the source volume to resolve the overcapacity condition of the source volume. In this manner, by moving data to storage units with cheaper data storage costs, the cost of storing data in the storage environment is reduced or minimized.

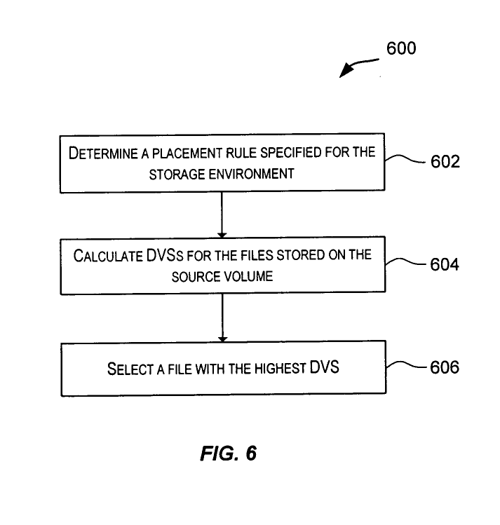

As indicated above, according to an embodiment of the present invention, DVSs may be used to select a file to be moved from the source volume to a target volume. FIG. 6 is a simplified flowchart 600 depicting a method of selecting a file for a move or migration operation according to an embodiment of the present invention. The processing depicted in FIG. 6 may be performed in step 410 depicted in FIG. 4 and/or step 506 depicted in FIG. 5. The processing in FIG. 6 may be performed by software modules executed by a processor, hardware modules, or combinations thereof. According to an embodiment of the present invention, the processing is performed by a policy management engine (PME) executing on SMS 110. Flowchart 600 depicted in FIG. 6 is merely illustrative of an embodiment of the present invention and is not intended to limit the scope of the present invention. Other variations, modifications, and alternatives are also within the scope of the present invention.

As depicted in FIG. 6, a placement rule specified for the storage environment is determined (step 602). Examples of placement rules according to an embodiment of the present invention are provided in U.S. patent application Ser. No. 10/232,875 filed Aug. 30, 2002 (Attorney Docket No. 21154-000210US), and described below. For sake of simplicity of description, it is assumed for the processing depicted in FIG. 6 that a single placement rule is defined for the storage environment.

Given the placement rule determined in step 602, data value scores (DVSs) are then calculated for the files stored on the source volume (step 604). The file with the highest DVS is then selected for the move operation (step 606). According to an embodiment of the present invention, the processing depicted in FIG. 6 is performed the first time that a file is to be selected. During this first pass, the files may be ranked based upon their DVSs calculated in step 606. The ranked list of files is then available for subsequent selections of the files during subsequent passes of the flowcharts depicted in FIGS. 4 and 5. The highest ranked and previously unselected file is then selected during each pass.

According to an embodiment of the present invention, files that contain migrated data are selected for the move operation before files that contain original data (i.e., files that have not been migrated). A migrated file comprises data that has been migrated or remigrated from its original storage location by applications such as HSM applications. Generally, a stub or tag file is left in the original storage location of the migrated file identifying the migrated location of the file. An original file represents a file that has not been migrated or remigrated.

Thus, according to an embodiment of the present invention, migrated files are moved before original files. In this embodiment, in step 606, two separate ranked lists are created based upon the DVSs associated with the files: one list comprising migrated files ranked based upon their DVSs, and the other comprising original files ranked based upon their DVSs. When a file is to be selected for a move operation in order to resolve an overcapacity condition associated with a volume, files from the ranked migrated files list are selected before selection of files from the ranked original files list (i.e., files from the original files list are not selected until the files on the migrated files list have been selected and moved).

According to an embodiment of the present invention, file groups may be configured for the storage environment. A file is included in a file group if the file satisfies criteria specified for the file group. The file group criteria may be specified by the administrator or some other user. For example, an administrator may create file groups based upon a business value associated with the files. The administrator may group files that are deemed important or critical for the business into one file group (a “more important” file group) and the other files may be grouped into a second group (a “less important” file group). Other criteria may also be used for defining file groups including file size, file type, file owner or group of owners, last modified time of the file, last access time of a file, etc. The file groups may be created by the administrator or automatically by a storage policy engine. The file groups may also be prioritized relative to each other depending upon the files included in the file groups. Based upon the priorities associated with the file groups, files from a certain file group may be selected for the move operation in step 606 before files from another group. For example, the move operation may be configured such that files from the “less important” file group are moved before files from the “more important” file group. Accordingly, in step 606, files from the “less important” file group are selected for the move operation before files from the “more important” file group. Within a particular file group, the DVSs associated with the files may determine the order in which the files are selected for the move operation.

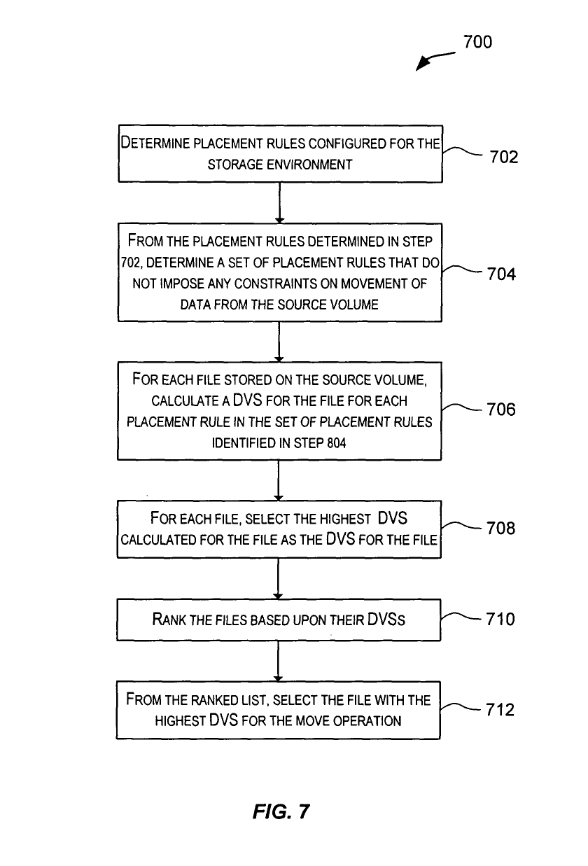

In FIG. 6 it was assumed that only one placement rule was configured for the storage environment. However, in other embodiments, multiple placement rules may be configured for a storage environment. FIG. 7 is a simplified flowchart 700 depicting a method of selecting a file for a move or migration operation according to an embodiment of the present invention wherein multiple placement rules are configured. The processing depicted in FIG. 7 may be performed in step 410 depicted in FIG. 4 and/or step 506 depicted in FIG. 5. The processing in FIG. 7 may be performed by software modules executed by a processor, hardware modules, or combinations thereof. According to an embodiment of the present invention, the processing is performed by a policy management engine (PME) executing on SMS 110. Flowchart 700 depicted in FIG. 7 is merely illustrative of an embodiment of the present invention and is not intended to limit the scope of the present invention. Other variations, modifications, and alternatives are also within the scope of the present invention.

As depicted in FIG. 7, the multiple placement rules configured for the storage environment are determined (step 702). Examples of placement rules according to an embodiment of the present invention are provided in U.S. patent application Ser. No. 10/232,875 filed Aug. 30, 2002 (Attorney Docket No. 21154-000210US), and described below.

A set of placement rules that do not impose any constraints on moving data from a source volume are then determined from the rules determined in step 702 (step 704). For each file stored on the source volume, a DVS is calculated for the file for each placement rule in the set of placement rules identified in step 704 (step 706). For each file, the highest DVS calculated for the file, from the DVSs generated for the file in step 704, is then selected as the DVS for that file (step 708). In this manner, a DVS is associated with each file. The files are then ranked based upon their DVSs (step 710). From the ranked list, the file with the highest DVS is then selected for the move operation (step 712).

According to an embodiment of the present invention, the processing depicted in FIG. 7 is performed the first time that a file is to be selected during the first pass of the flowcharts depicted in FIGS. 4 and 5. During this first pass, the files may be ranked based upon their DVSs in step 710. The ranked list of files is then available for subsequent selections of the files during subsequent passes of the flowcharts depicted in FIGS. 4 and 5. The highest ranked and previously unselected file is then selected during each subsequent pass.

According to an embodiment of the present invention, files that contain migrated data are selected for the move operation before files that contain original data (i.e., files that have not been migrated). A migrated file comprises data that has been migrated (or remigrated) from its original storage location by applications such as HSM applications. Generally, a stub or tag file is left in the original storage location of the migrated file identifying the migrated location of the file. An original file represents a file that has not been migrated or remigrated.

Thus, according to an embodiment of the present invention, migrated files are moved before original files. In this embodiment, in step 712, two separate ranked lists are created based upon the DVS scores associated with the files: one list comprising migrated files, and the other comprising original files. When a file is to be selected for a move operation, files from the ranked migrated files list are selected before selection of files from the ranked original files list (i.e., files from the original files list are not selected until the files on the migrated files list have been selected and moved).

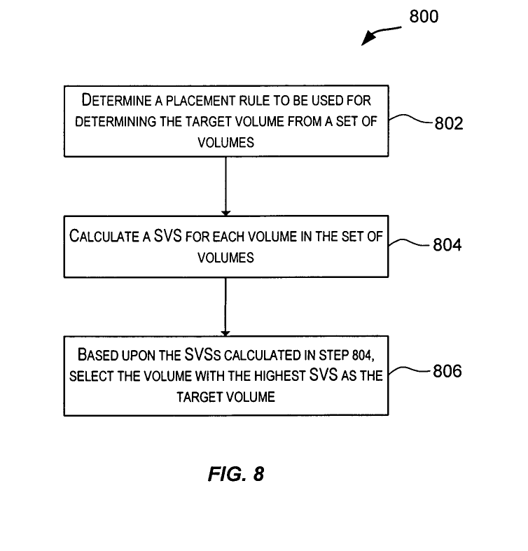

As indicated above, according to an embodiment of the present invention, a target volume may be selected from multiple volumes based upon SVSs. FIG. 8 is a simplified flowchart 800 depicting a method of selecting a target volume from a set of volumes according to an embodiment of the present invention. The processing depicted in FIG. 8 may be performed in step 412 depicted in FIG. 4 and/or step 508 depicted in FIG. 5. The processing in FIG. 8 may be performed by software modules executed by a processor, hardware modules, or combinations thereof. According to an embodiment of the present invention, the processing is performed by a policy management engine (PME) executing on SMS 110. Flowchart 800 depicted in FIG. 8 is merely illustrative of an embodiment of the present invention and is not intended to limit the scope of the present invention. Other variations, modifications, and alternatives are also within the scope of the present invention.

As depicted in FIG. 8, a placement rule to be used for determining a target volume from a set of volumes is determined (step 802). In an embodiment where a single placement rule is configured for the storage environment, that single placement rule is selected in step 802. In embodiments where multiple placement rules are configured for the storage environment, the placement rule selected in step 802 corresponds to the placement rule that that was used to calculate the DVS associated with the selected file.

Using the placement rule determined in step 802, a storage value score (SVS) (or “relative storage value score” RSVS) is generated for each volume in the set of volumes (e.g., volumes in the selected target managed group) (step 804). The SVS for a volume indicates the degree of suitability of storing the selected file on that volume. Various techniques may be used for calculating the SVSs. According to an embodiment of the present invention, the SVSs may be calculated using techniques described in U.S. patent application Ser. No. 10/232,875 filed Aug. 30, 2002 (Attorney Docket No.21154-000210US), and described below. The SVSs are referred to as relative storage value scores (RSVSs) in U.S. patent application Ser. No. 10/232,875. The volume with the highest SVS score is then selected as the target volume (step 806).

In the flowcharts depicted in FIGS. 4 and 5, the SVSs are calculated every time that a target volume is to be determined (for example, in step 412 in FIG. 4 and in step 508 in FIG. 5) for storing the selected file, as the SVS for a particular volume may change based upon the conditions associated with the volume. Accordingly, different volumes may be selected as target volumes during successive passes of the flowchart depicted in FIG. 8. Embodiments of the present invention thus provide the ability to automatically and dynamically select a volume for moving data based upon the dynamic conditions associated with the volumes.

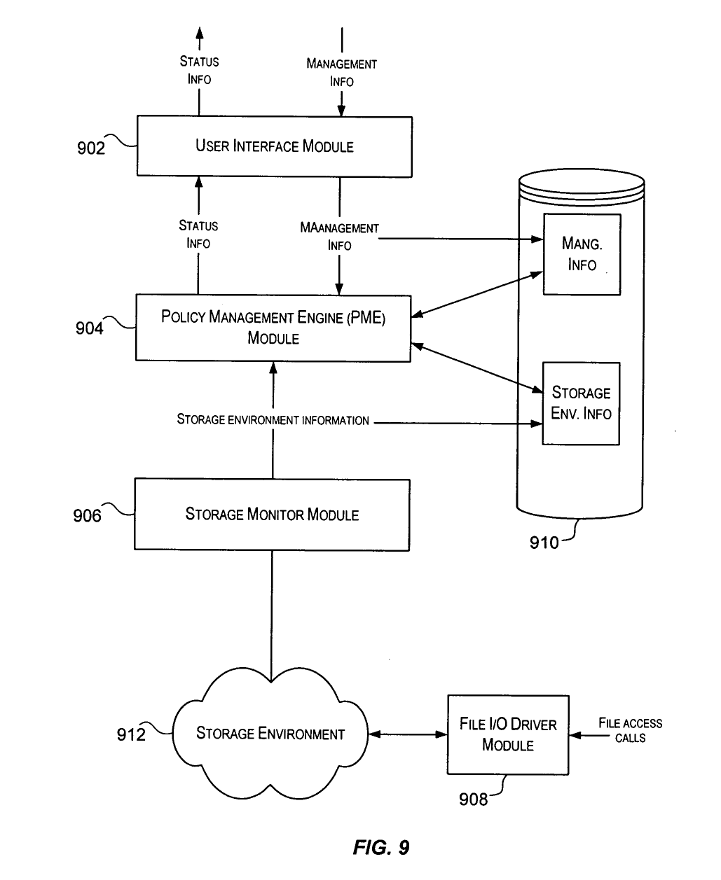

FIG. 9 is a simplified block diagram showing modules that may be used to implement an embodiment of the present invention. The modules depicted in FIG. 9 may be implemented in software, hardware, or combinations thereof. As shown in FIG. 9, the modules include a user interface module 902, a policy management engine (PME) module 804, a storage monitor module 906, and a file I/O driver module 908. It should be understood that the modules depicted in FIG. 9 are merely illustrative of an embodiment of the present invention and are not meant to limit the scope of the invention. One of ordinary skill in the art would recognize other variations, modifications, and alternatives.

User interface module 902 allows a user (e.g., an administrator) to interact with the storage management system. An administrator may provide rules/policy information for managing storage environment 912, information identifying the managed groups of storage units, thresholds information, selection criteria, cost criteria, etc., via user interface module 902. The information provided by the user may be stored in memory and disk storage 910. Information related to storage environment 912 may be output to the user via user interface module 902. The information related to the storage environment that is output may include status information about the capacity of the various storage units in the storage environment, the status of capacity utilization balancing operations, data storage costs information, error conditions, and other information related to the storage system. User interface module 902 may also provide interfaces that allow a user to define the managed groups of storage units using one or more techniques described above.

User interface module 902 may be implemented in various forms. For example, user interface 902 may be in the form of a browser-based user interface, a graphical user interface, text-based command line interface, or any other application that allows a user to specify information for managing a storage environment and that enables a user to receive feedback, statistics, reports, status, and other information related to the storage environment.

The information received via user interface module 902 may be stored in a memory and disk storage 910 and/or forwarded to PME module 904. The information may be stored in the form of configuration files, Windows Registry, a directory service (e.g., Microsoft Active Directory, Novell eDirectory, OpenLDAP, etc), databases, and the like. PME module 804 is also configured to read the information from memory and disk storage 910.

Policy management module 904 is configured to perform the processing to optimize capacity utilization and move data between storage units based upon data storage costs according to an embodiment of the present invention. Policy management module 904 uses information received from user interface module 902 (or stored in memory and disk storage 910) and information related to storage environment 912 received from storage monitor module 906 to automatically perform the capacity utilization balancing task. Information specifying costs for storing data on the various storage units is also used for the capacity utilization balancing. According to an embodiment of the present invention, PME module 904 is configured to perform the processing depicted in FIGS. 4, 5, 6, 7, and 8.

Storage monitor module 906 is configured to monitor storage environment 912. The monitoring may be done on a continuous basis or on a periodic basis. As described above, the monitoring may include monitoring attributes of the storage units such as usage information, capacity utilization, types of storage devices, etc. Monitoring also includes monitoring attributes of the files in storage environment 912 such as file size information, file access time information, file type information, etc. The monitoring may also be performed using agents installed on the various servers coupled to the storage units or may be done remotely from agents running on other systems. The information gathered from the monitoring activities may be stored in memory and disk storage 910 or forwarded to PME module 904.

Various formats may used for storing the information in memory and disk storage 910. For example, the storage capacity usage for a storage unit may be expressed as a percentage of the total storage capacity of the storage unit. For example, if the total storage capacity of a storage unit is 100 Mbytes, and if 40 Mbytes are free for storage (i.e., 60 Mbytes are already used), then the used storage capacity of the storage unit may be expressed as 60% (or alternatively, 40% available capacity). The value may also be expressed as the amount of free storage capacity (e.g., in MB, GB, etc.) or used storage.

PME module 904 may use the information gathered from the monitoring to detect presence of conditions that trigger a storage capacity optimization operation. For example, PME module 904 may use the gathered information to determine if a storage unit in storage environment 912 is experiencing an overcapacity condition.

File I/O driver module 908 is configured to intercept file system calls received from consumers of data stored by storage environment 912. For example, file I/O driver module 908 is configured to intercept any file open call (which can take different forms in different operating systems) received from an application, user, or any data consumer. When file I/O driver module 908 determines that a requested file has been migrated from its original location to a different location, it may suspend the file open call and perform the following operations: (1) File I/O driver 908 may determine the actual location of the requested data file in storage environment 912. This can be done by looking up from the file header or stub file that is stored in the original location. Alternatively, if the file location information is stored in a persistent storage location (e.g., a database managed by PME module 904), file I/O driver 908 may determine the actual remote location of the file from that persistent location;

(2) File I/O driver 908 may then restore the file content from the remote storage unit location; (3) File I/O driver 908 then resumes the file open call so that the application can resume with the restored data.

Techniques for Generating DVSs and SVSs Using Placement Rules

As described above, an embodiment of the present invention can automatically determine files to be moved and target storage units for storing the files using DVSs and SVSs calculated using one or more placement rules. According to an embodiment of the present invention, each placement rule comprises: (1) data-related criteria and (2) device-related criteria. The data-related criteria comprises criteria associated with the data to be stored and is used to select the file to move. According to an embodiment, the data-related criteria comprise (a) data usage criteria information, and (b) file selection criteria information.

The device-related criteria comprises criteria related to storage units. In one embodiment, the device related criteria is also referred to as location constraint criteria information.

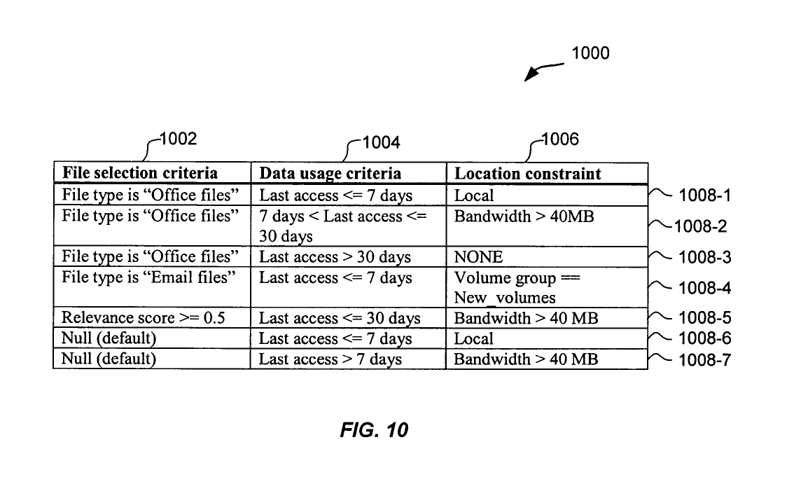

FIG. 10 depicts examples of placement rules according to an embodiment of the present invention. In FIG. 10, each row 1008 of table 1000 specifies a placement rule. Column 1002 of table 1000 identifies the file selection criteria information for each rule, column 1004 of table 1000 identifies the data usage criteria information for each placement rule, and column 1006 of table 1000 identifies the location constraint criteria information for each rule.

The “file selection criteria information” specifies information identifying conditions related to files. According to an embodiment of the present invention, the selection criteria information for a placement rules specifies one or more clauses (or conditions) related to an attribute of a file such as file type, relevance score of file, file owner, etc. Each clause may be expressed as an absolute value (e.g., File type is “Office files”) or as an inequality (e.g., Relevance score of file>=0.5). Multiple clauses may be connected by Boolean connectors (e.g., File type is “Email files” AND File owner is “John Doe”) to form a Boolean expression. The file selection criteria information may also be left empty (i.e., not configured or set to NULL value), e.g., file selection criteria for placement rules 1008-6 and 1008-7 depicted in FIG. 10. According to an embodiment of the present invention, the file selection criteria information defaults to a NULL value. An empty or NULL file selection criterion is valid and indicates that all files are selected or are eligible for the placement rule.

The “data usage criteria information” specifies criteria related to file access information associated with a file. For example, for a particular placement rule, this information may specify condition related to when the file was last accessed, created, last modified, and the like. The criteria may be specified using one or more clauses or conditions connected using Boolean connectors. The data usage criteria clauses may be specified as equality conditions or inequality conditions. For example, “file last accessed between 7 days to 30 days ago” (corresponding to placement rule 1008-2 depicted in FIG. 10). These criteria may be set by an administrator.

The “location constraint information” for a particular placement rule specifies one or more constraints associated with storing information on a storage unit based upon the particular placement rule. Location constraint information generally specifies parameters associated with a storage unit that need to be satisfied for storing information on the storage unit. The location constraint information may be left empty or may be set to NULL to indicate that no constraints are applicable for the placement rule. For example, no constraints have been specified for placement rule 1008-3 depicted in FIG. 10.

According to an embodiment of the present invention, the constraint information may be set to LOCAL (e.g., location constraint information for placement rules 1008-1 and 1008-6). This that the file is to be stored on a local storage unit that is local to the device used to create the file and is not to be moved or migrated to another storage unit. According to an embodiment of the present invention, a placement rule is not eligible for selection if the constraint information is set to LOCAL, and a DVS of 0 (zero) is assigned for that specific placement rule. A specific storage unit group, or a specific device may be specified in the location constraint information for storing the data file. A minimum bandwidth requirement (e.g., Bandwidth>=10 MB/s) may be specified indicating that the data can only be stored on a storage unit satisfying the constraint. Various other constraints or requirements may also be specified (e.g., constraints related to file size, availability, etc.). The constraints specified by the location constraint information are generally hard constraints implying that a file cannot be stored on a storage unit that does not satisfy the location constraints.

As stated above, a numerical score (referred to as the Data Value Score or DVS) can be generated for a file for each placement rule. For each placement rule, the DVS generated for the file and the placement rule indicates the level of suitability or applicability of the placement rule for that file. The value of the DVS calculated for a particular file using a particular placement rule is based upon the characteristics of the particular file. For example, according to an embodiment of the present invention, for a particular file, higher scores are generated for placement rules that are deemed more suitable or relevant to the particular file.

Several different techniques may be used for generating a DVS for a file using a placement rule. According to one embodiment, the DVS for a file using a placement rule is a simple product of a “file_selection_score” and a “data_usage_score”,

i.e., DVS=file_selection_score* data_usage_score

In the above equation, the file_selection_score and the data_usage_score are equally weighed in the calculation of DVS. However, in alternative embodiments, differing weights may be allocated to the file_selection_score and the data_usage_score to emphasize or deemphasize their effect. According to an embodiment of the present invention, the value of DVS for a file using a placement rule is in the range between 0 and 1 (both inclusive).

According to an embodiment of the present invention, the file_selection_score (also referred to as the “data characteristics score”) for a placement rule is calculated based upon the file selection criteria information of the placement rule and the data_usage_score for the placement rule is calculated based upon the data usage criteria information specified for the placement rule.

As described above, the file selection criteria information and the data usage criteria information specified for the placement rule may comprise one or more clauses or conditions involving one or more parameters connected by Boolean connectors (see FIG. 10). Accordingly, calculation of the file_selection_score involves calculating numerical values for the individual clauses that make up the file selection criteria information for the placement rule and then combining the individual clause scores to calculate the file_selection_score for the placement rule. Likewise, calculation of the data_usage_score involves calculating numerical values for the individual clauses specified for the data usage criteria information for the placement rule and then combining the individual clause scores to calculate the data_usage_score for the placement rule.

According to an embodiment of the present invention, the following rules are used to combine scores generated for the individual clauses to calculate a file_selection_score or data_usage_score:

Rule 1: For an N-way AND operation (i.e., for N clauses connected by an AND connector), the resultant value is the sum of all the individual values calculated for the individual clauses divided by N.

Rule 2: For an N-way OR operation (i.e., for N clauses connected by an OR connector), the resultant value is the largest value calculated for the N clauses.

Rule 3: According to an embodiment of the present invention, the file_selection_score and the data_usage_score are between 0 and 1 (both inclusive).

According to an embodiment of the present invention, the value for each individual clause specified in the file selection criteria is calculated using the following guidelines:

(a) If a NULL (or empty) value is specified in the file selection criteria information then the NULL or empty value gets a score of 1. For example, the file_selection_score for placement rule 1008-7 depicted in FIG. 10 is set to 1.

(b) For file type and ownership parameter evaluations, a score of 1 is assigned if the parameter criteria are met, else a score of 0 is assigned. For example, for placement rule 1008-4 depicted in FIG. 10, if the file for which the DVS is calculated is of type “Email Files”, then a score of 1 is assigned for the clause. The file_selection_score for placement rule 308-4 is also set to 1 since it comprises only one clause. However, if the file is not an email file, then a score of 0 is assigned for the clause and accordingly the file_selection_score is also set to 0.

(c) If a clause involves an equality test of the “relevance score” (a relevance score may be assigned for a file by an administrator), the score for the clause is calculated using the following equations:

RelScore_{Data}=Relevance score of the file

RelScore_{Rule}=Relevance score specified in the file selection criteria information

Delta=abs(RelScore_{Data}−RelScore_{Rule})

Score=1−(Delta/RelScore_{Rule})

The Score is reset to 0 if it is negative.

(d) If the clause involves an inequality test (e.g., using >, >=, < or <=) related to the “relevance score” (e.g., rule 1008-5 in FIG. 10), the score for the clause is calculated using the following equations:

The Score is set to 1 if the parameter inequality is satisfied.

RelScore_{Data}=Relevance score of the data file

RelScore_{Rule}=Relevance score specified in the file selection criteria information

Delta=abs(RelScore_{Data}−RelScore_{Rule})

Score=1−(Delta/RelScore_{Rule})

The Score is reset to 0 if it is negative.

Once score for the individual clauses have been calculated, the file_selection_score is then calculated based on the individual scores for the clauses in the file selection criteria information using Rules 1, 2, and 3, as described above. The file_selection_score represents the degree of matching (or suitability) between the file selection criteria information for a particular placement rule and the file for which the score is calculated. It should be evident that various other techniques may also be used to calculate the file_selection_score in alternative embodiments of the present invention.

According to an embodiment of the present invention, the score for each clause specified in the data usage criteria information for a placement rule is scored using the following guidelines:

The score for the clause is set to 1 if the parameter condition of the clause is met.

Date_{Data}=Relevant date information for the data file.

Date_{Rule}=Relevant date information in the rule.

Delta=abs(Date_{Data}−Date_{Rule})

Score=1−(Delta/Date_{Rule})

The Score is reset to 0 if it is negative.

If a date range is specified in the clause (e.g., last 7 days), the date range is converted back to the absolute date before the evaluation is made. The data_usage_score is then calculated based upon scores for the individual clauses specified in the file selection criteria information using Rules 1, 2, and 3, as described above.

It should be evident that various other techniques may also be used to calculate the data_usage_score in alternative embodiments of the present invention. The data_usage_score represents the degree of matching (or suitability) between the data usage criteria information for a particular placement rule and the file for which the score is calculated.

The DVS is then calculated based upon the file_selection_score and data_usage_score. The DVS for a placement rule thus quantifies the degree of matching (or suitability) between the conditions specified in the file selection criteria information and the data usage criteria information for the placement rule and the characteristics of the file for which the score is calculated. According to an embodiment of the present invention, higher scores are generated for placement rules that are deemed more suitable (or are more relevant) for the file.

Several different techniques may be used for ranking the placement rules for a file. The rules are initially ranked based upon DVSs calculated for the placement rules. According to an embodiment of the present invention, if two or more placement rules have the same DVS value, then the following tie-breaking rules may be used:

(a) The placement rules are ranked based upon priorities assigned to the placement rules by a user (e.g., system administrator) of the storage environment.

(b) If the priorities are not set or are equal, then the total number of top level AND operations (i.e., number of clauses connected using AND connectors) used in calculating the file_selection_score and the data_usage_score for a placement rule are used as a tie-breaker. A particular placement rule having a greater number of AND operations that are used in calculating file_selection_score and data_usage_score for the particular rule is ranked higher than another rule having a lesser number of AND operations. The rationale here is that a more specific configuration (indicated by a higher number of clauses connected using AND operations) of the file selection criteria and the data usage criteria is assumed to carry more weight than a more general specification.

(c) If neither (a) nor (b) are able to break the tie between placement rules, some other criteria may be used to break the tie. For example, according to an embodiment of the present invention, the order in which the placement rules are encountered may be used to break the tie. In this embodiment, a placement rule that is encountered earlier is ranked higher than a subsequent placement rule. Various other criteria may also be used to break ties. It should be evident that various other techniques may also be used to rank the placement rules in alternative embodiments of the present invention.

All files that meet all the selection criteria for movement are assigned a DVS of 1, as calculated from the above steps. According to an embodiment of the present invention, in order to break ties, the files are then ranked again by recalculating the DVS using another equation. In one embodiment, the new DVS score equation is defined as:

DVS=file_size/last_access_time

where:

file_size is the size of the file; and

last_access_time is the last time that the file was accessed.

It should be noted that this DVS calculation ranks the files based on their impacts to the overall system when they are moved from the source volume, with a higher score representing a lower impact. In this embodiment, moving a larger file is more effective to balance capacity utilization and moving a file that has not been accessed recently reduces the chances that the file will be recalled. It should be evident that various other techniques may also be used to rank files that have a DVS of 1 in alternative embodiments of the present invention.

As previously stated, placement rules are also used to calculate SVSs for storage units in order to identify a target storage unit. According to an embodiment of the present invention, a SVS for a storage unit is calculated using the following steps:

STEP 1: A “Bandwidth_factor” variable is set to zero (0) if the bandwidth supported by the storage unit for which the score is calculated is less than the bandwidth requirement, if any, specified in the location constraints criteria specified for the placement rule for which the score is calculated. For example, the location constraint criteria for placement rule 1008-2 depicted in FIG. 10 specifies that the bandwidth of the storage unit should be greater than 40 MB. Accordingly, if the bandwidth supported by the storage unit is less than 40 MB, then the “Bandwidth_factor” variable is set to 0.

Otherwise, the value of “Bandwidth_factor” is set as follows:

Bandwidth_factor=((Bandwidth supported by the storage unit)−(Bandwidth required by the location constraint of the selected placement rule))+K

where K is set to some constant integer. According to an embodiment of the present invention, K is set to 1. Accordingly, the value of Bandwidth_factor is set to a non-negative value.

STEP 2: SVS is calculated as follows:

SVS=Bandwidth_factor *(desired_threshold_%−current_usage_%)/cost

As described above, the desired_threshold_% for a storage device is usually set by a system administrator. The current_usage_% value is monitored by embodiments of the present invention. The “cost” value may be set by the system administrator.

It should be understood that the formula for calculating SVS shown above is representative of one embodiment of the present invention and is not meant to reduce the scope of the present invention. Various other factors may be used for calculating the SVS in alternative embodiments of the present invention. For example, the availability of a storage unit may also be used to determine the SVS for the device. According to an embodiment of the present invention, availability of a storage unit indicates the amount of time that the storage unit is available during those time periods when it is expected to be available. Availability may be measured as a percentage of an elapsed year in certain embodiments. For example, 99.95% availability equates to 4.38 hours of downtime in a year (0.0005*365 *24=4.38) for a storage unit that is expected to be available all the time. According to an embodiment of the present invention, the value of SVS for a storage unit is directly proportional to the availability of the storage unit.

STEP 3: Various adjustments may be made to the SVS calculated according to the above steps. For example, in some storage environments, the administrator may want to group “similar” files together in one storage unit. In other environments, the administrator may want to distribute files among different storage units. The SVS may be adjusted to accommodate the policy adopted by the administrator. Performance characteristics associated with a network that is used to transfer data from the storage devices may also be used to adjust the SVSs for the storage units. For example, the access time (i.e., the time required to provide data stored on a storage unit to a user) of a storage unit may be used to adjust the SVS for the storage unit. The throughput of a storage unit may also be used to adjust the SVS value for the storage unit. Accordingly, parameters such as the location of the storage unit, location of the data source, and other network related parameters might also be used to generate SVSs. According to an embodiment of the present invention, the SVS value is calculated such that it is directly proportional to the desirability of the storage unit for storing the file.

According to an embodiment of the present invention, a higher SVS value represents a more desirable storage unit for storing a file. As indicated, the SVS value is directly proportional to the available capacity percentage. Accordingly, a storage unit with higher available capacity is more desirable for storing a file. The SVS value is inversely proportional to the cost of storing data on the storage unit. Accordingly, a storage unit with lower storage costs is more desirable for storing a file. The SVS value is directly proportional to the bandwidth requirement. Accordingly, a storage unit supporting a higher bandwidth is more desirable for storing the file. SVS is zero if the bandwidth requirements are not satisfied. Accordingly, the SVS formula for a particular storage unit combines the various storage unit characteristics to generate a score that represents the degree of desirability of storing data on the particular storage unit.

According to the above formula, SVS is zero (0) if the value of Bandwidth_factor is zero. As described above, Bandwidth_factor is set to zero if the bandwidth supported by the storage unit is less than the bandwidth requirement, if any, specified in the location constraints criteria information specified for the selected placement rule. Accordingly, if the value of SVS for a particular storage unit is zero (0) it implies that bandwidth supported by the storage unit is less than the bandwidth required by the placement rule, or the storage unit is already at or exceeds the desired capacity threshold. Alternatively, SVS is zero (0) if the desired_threshold_% is equal to the current_usage_%.

If the SVS for a storage unit is positive, it indicates that the storage unit meets both the bandwidth requirements (i.e., Bandwidth_factor is non zero) and also has enough capacity for storing the file (i.e., desired_threshold_% is greater than the current_usage_%). The higher the SVS value, the more suitable (or desirable) the storage unit is for storing a file. For storage units with positive SVSs, the storage unit with the highest positive RSVS is the most desirable candidate for storing the file. The SVS for a particular storage unit thus provides a measure for determining the degree of desirability for storing data on the particular storage unit relative to other storage unit for a particular placement rule being processed. Accordingly, the SVS is also referred to as the relative storage value score (RSVS). The SVS in conjunction with the placement rules and their rankings is used to determine an optimal storage location for storing the data to be moved from the source storage unit.

The SVS for a particular storage unit may be negative if the storage unit meets the bandwidth requirements but the storage unit's usage is above the intended threshold (i.e., current_usage_% is greater than the desired_threshold_%). The relative magnitude of the negative value indicates the degree of over-capacity of the storage unit. Among storage units with negative SVSs, the closer the SVS is to zero (0) and the storage unit has capacity for storing the data, the more desirable the storage unit is for storing the data file. For example, the over-capacity of a storage unit having SVS of −0.9 is more than the over-capacity of a second storage unit having RSVS −0.1. Accordingly, the second storage unit is a more attractive candidate for storing the data file as compared to the first storage unit. Accordingly, the SVS, even if negative, can be used in ranking the storage units relative to each other for purposes of storing data.

The SVS for a particular storage unit thus serves as a measure for determining the degree of desirability or suitability of the particular storage unit for storing data relative to other storage devices. A storage unit having a positive SVS value is a better candidate for storing the data file than a storage unit with a negative SVS value, since a positive value indicates that the storage unit meets the bandwidth requirements for the data file and also possesses sufficient capacity for storing the data file. Among storage units with positive SVS values, a storage unit with a higher positive SVS is a more desirable candidate for storing the data file than a storage unit with a lower SVS value, i.e., the storage unit having the highest positive SVS value is the most desirable storage unit for storing the data file.

If a storage unit with a positive SVS value is not available, then storage units with negative SVS values are more desirable than devices with an SVS value of zero (0). The rationale here is that it is better to select a storage unit that satisfies the bandwidth requirements (even though the storage unit is over capacity) than a storage unit that does not meet the bandwidth requirements (i.e., has a SVS of zero). Among storage units with negative SVS values, a storage unit with a higher SVS value (i.e., SVS closer to 0) is a more desirable candidate for storing the data file than a storage unit with a lesser SVS value. Accordingly, among storage units with negative SVS values, the storage unit with the highest SVS value (i.e., SVS closest to 0) is the most desirable candidate for storing the data file.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps. It should be understood that the equations described above are only illustrative of an embodiment of the present invention and can vary in alternative embodiments of the present invention.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A computer-implemented method of managing a storage environment comprising a plurality of storage units, the method comprising:
detecting a condition associated with a first storage unit from the plurality of storage units;
determining a first group from a plurality of groups to which the first storage unit belongs, wherein each group comprises one or more storage units from the plurality of storage units and inclusion of a storage unit in a group depends on a cost of storing data on the storage unit;
identifying a second group from the plurality of groups having an associated data storage cost that is lower than a data storage cost associated with the first group;
identifying a file stored on the first storage unit to be moved;
identifying a storage unit from the second group for storing the file; and
moving the file from the first storage unit to the storage unit from the second group that has been identified for storing the file.

2. The method of claim 1 further comprising repeating, the identifying a file stored on the first storage unit to be moved, the identifying a storage unit from the second group for storing the file, and the moving the file from the first storage unit to the storage unit from the second group that has been identified for storing the file, until the condition is resolved.

3. The method of claim 2 wherein the first storage unit stores a set of migrated files and a set of original files, the set of migrated files comprising files that have been migrated or remigrated from their original storage locations, the set of original files comprising files that have not been migrated from their original storage locations, and wherein a file from the set of original files is not selected to be moved until all files in the set of migrated files have been selected and moved from the first storage unit.

4. The method of claim 2 wherein detecting a condition associated with the first storage unit comprises detecting that used storage capacity for the first storage unit has exceeded a first threshold, and the condition is resolved when the used storage capacity for the first storage unit does not exceed the first threshold.

5. The method of claim 1 wherein identifying a storage unit from the second group comprises identifying a storage unit from one or more storage units in the second group that is least full.

6. The method of claim 1 wherein identifying a storage unit from the second group comprises:
generating a score for each storage unit in the second group; and
selecting a storage unit from the second group based upon the scores generated for the one or more storage units in the second group.

7. The method of claim 1 wherein the first storage unit stores a plurality of files and identifying a file stored on the first storage unit to be moved comprises:
generating a score for each file in the plurality of files stored on the first storage unit; and
selecting a file to be moved from the plurality of files based upon the scores generated for the files in the plurality of files.

8. The method of claim 1 wherein the first storage unit is assigned to a first server and the storage unit from the second group to which the file from the first storage unit is moved is assigned to a second server distinct from the first server.

9. A computer-implemented method of managing a storage environment comprising a plurality of storage units, the method comprising:
detecting a condition associated with a first storage unit from the plurality of storage units;
identifying a file stored on the first storage unit to be moved;
identifying a storage unit from the plurality of storage units for storing the file, wherein the data storage cost associated with identified storage unit is lower than a data storage cost associated with the first storage unit; and
moving the file from the first storage unit to the storage unit from the second group that has been identified for storing the file.

10. The method of claim 9 wherein identifying a storage unit from the plurality of storage units for storing the file comprises:
identifying a set of storage units from the plurality of storage units that have an associated data storage cost that is lower than the data storage cost associated with the first storage unit; and
selecting a storage unit for storing the file from the set of storage units.

11. The method of claim 9 further comprising repeating, the identifying a file stored on the first storage unit to be moved, the identifying a storage unit from the plurality of storage units for storing the file, and the moving the file from the first storage unit to the storage unit from the second group that has been identified for storing the file, until the condition is resolved.

12. The method of claim 11 wherein detecting a condition associated with the first storage unit comprises detecting that used storage capacity for the first storage unit has exceeded a first threshold, and the condition is considered resolved when the used storage capacity for the first storage unit does not exceed the first threshold.

13. The method of claim 11 wherein the first storage unit stores a set of migrated files and a set of original files, the set of migrated files comprising files that have been migrated or remigrated from their original storage locations, the set of original files comprising files that have not been migrated from their original storage locations, and wherein a file from the set of original files is not selected to be moved until all files in the set of migrated files have been selected and moved from the first storage unit.

14. The method of claim 9 wherein identifying a storage unit from the plurality of storage units for storing the file comprises identifying a storage unit from the plurality of storage units that is least full.

15. The method of claim 9 wherein identifying a storage unit from the plurality of storage units for storing the file comprises:
generating scores for storage units in the plurality of storage units; and
selecting a storage unit from the plurality of storage units based upon the generated scores.

16. The method of claim 9 wherein the first storage unit stores a plurality of files and identifying a file stored on the first storage unit to be moved comprises:
generating a score for each file in the plurality of files stored on the first storage unit; and
selecting a file to be moved from the plurality of files based upon the scores generated for the files in the plurality of files.

17. The method of claim 9 wherein the first storage unit is assigned to a first server and the storage unit from the plurality of storage units to which the file from the first storage unit is moved is assigned to a second server distinct from the first server.

18. A computer program product stored on a computer-readable storage medium for managing a storage environment comprising a plurality of storage units, the computer program product comprising:
code for detecting a condition associated with a first storage unit from the plurality of storage units;
code for determining a first group from a plurality of groups to which the first storage unit belongs, wherein each group comprises one or more storage units from the plurality of storage units and inclusion of a storage unit in a group depends on a cost of storing data on the storage unit;
code for identifying a second group from the plurality of groups having an associated data storage cost that is lower than a data storage cost associated with the first group;
code for identifying a file stored on the first storage unit to be moved;
code for identifying a storage unit from the second group for storing the file; and
code for moving the file from the first storage unit to the storage unit from the second group that has been identified for storing the file.

19. The computer program product of claim 18 further comprising code for repeating, the identifying a file stored on the first storage unit to be moved, the identifying a storage unit from the second group for storing the file, and the moving the file from the first storage unit to the storage unit from the second group that has been identified for storing the file, until the condition is resolved.

20. The computer program product of claim 19 wherein the first storage unit stores a set of migrated files and a set of original files, the set of migrated files comprising files that have been migrated or remigrated from their original storage locations, the set of original files comprising files that have not been migrated from their original storage locations, and wherein a file from the set of original files is not selected to be moved until all files in the set of migrated files have been selected and moved from the first storage unit.

21. The computer program product of claim 19 wherein the code for detecting a condition associated with the first storage unit comprises code for detecting that used storage capacity for the first storage unit has exceeded a first threshold, and the condition is resolved when the used storage capacity for the first storage unit does not exceed the first threshold.

22. The computer program product of claim 18 wherein the code for identifying a storage unit from the second group comprises code for identifying a storage unit from one or more storage units in the second group that is least full.

23. The computer program product of claim 18 wherein the code for identifying a storage unit from the second group comprises:
code for generating a score for each storage unit in the second group; and
code for selecting a storage unit from the second group based upon the scores generated for the one or more storage units in the second group.

24. The computer program product of claim 18 wherein the first storage unit stores a plurality of files and the code for identifying a file stored on the first storage unit to be moved comprises:
code for generating a score for each file in the plurality of files stored on the first storage unit; and
code for selecting a file to be moved from the plurality of files based upon the scores generated for the files in the plurality of files.

25. The computer program product of claim 18 wherein the first storage unit is assigned to a first server and the storage unit from the second group to which the file from the first storage unit is moved is assigned to a second server distinct from the first server.

26. A computer program product stored on a computer-readable storage medium for managing a storage environment comprising a plurality of storage units, the computer program product comprising:
code for detecting a condition associated with a first storage unit from the plurality of storage units;
code for identifying a file stored on the first storage unit to be moved;
code for identifying a storage unit from the plurality of storage units for storing the file, wherein the data storage cost associated with identified storage unit is lower than a data storage cost associated with the first storage unit; and
code for moving the file from the first storage unit to the storage unit from the second group that has been identified for storing the file.

27. The computer program product of claim 26 wherein the code for identifying a storage unit from the plurality of storage units for storing the file comprises:
code for identifying a set of storage units from the plurality of storage units that have an associated data storage cost that is lower than the data storage cost associated with the first storage unit; and
code for selecting a storage unit for storing the file from the set of storage units.

28. The computer program product of claim 26 further comprising code for repeating, the identifying a file stored on the first storage unit to be moved, the identifying a storage unit from the plurality of storage units for storing the file, and the moving the file from the first storage unit to the storage unit from the second group that has been identified for storing the file, until the condition is resolved.

29. The computer program product of claim 28 wherein the code for detecting a condition associated with the first storage unit comprises code for detecting that used storage capacity for the first storage unit has exceeded a first threshold, and the condition is considered resolved when the used storage capacity for the first storage unit does not exceed the first threshold.

30. The computer program product of claim 28 wherein the first storage unit stores a set of migrated files and a set of original files, the set of migrated files comprising files that have been migrated or remigrated from their original storage locations, the set of original files comprising files that have not been migrated from their original storage locations, and wherein a file from the set of original files is not selected to be moved until all files in the set of migrated files have been selected and moved from the first storage unit.

31. The computer program product of claim 26 wherein the code for identifying a storage unit from the plurality of storage units for storing the file comprises code for identifying a storage unit from the plurality of storage units that is least full.

32. The computer program product of claim 26 wherein the code for identifying a storage unit from the plurality of storage units for storing the file comprises:
code for generating scores for storage units in the plurality of storage units; and
code for selecting a storage unit from the plurality of storage units based upon the generated scores.

33. The computer program product of claim 26 wherein the first storage unit stores a plurality of files and the code for identifying a file stored on the first storage unit to be moved comprises:
code for generating a score for each file in the plurality of files stored on the first storage unit; and
code for selecting a file to be moved from the plurality of files based upon the scores generated for the files in the plurality of files.

34. The computer program product of claim 26 wherein the first storage unit is assigned to a first server and the storage unit from the plurality of storage units to which the file from the first storage unit is moved is assigned to a second server distinct from the first server.

35. A system comprising:
a plurality of storage units; and
a data processing system configured to manage the plurality of storage units, wherein the data processing system is configured to:
detect a condition associated with a first storage unit from the plurality of storage units;
determine a first group from a plurality of groups to which the first storage unit belongs, wherein each group comprises one or more storage units from the plurality of storage units and inclusion of a storage unit in a group depends on a cost of storing data on the storage unit;
identify a second group from the plurality of groups having an associated data storage cost that is lower than a data storage cost associated with the first group;
identify a file stored on the first storage unit to be moved;
identify a storage unit from the second group for storing the file; and
move the file from the first storage unit to the storage unit from the second group that has been identified for storing the file.

36. The system of claim 35 wherein the data processing system is configured to repeat, the identification of a file stored on the first storage unit to be moved, the identification of a storage unit from the second group for storing the file, and the move of the file from the first storage unit to the storage unit from the second group that has been identified for storing the file, until the condition is resolved.

37. The system of claim 36 wherein the first storage unit stores a set of migrated files and a set of original files, the set of migrated files comprising files that have been migrated or remigrated from their original storage locations, the set of original files comprising files that have not been migrated from their original storage locations, and wherein a file from the set of original files is not selected to be moved until all files in the set of migrated files have been selected and moved from the first storage unit.

38. The system of claim 36 wherein the data processing system is configured to detect that used storage capacity for the first storage unit has exceeded a first threshold, and the condition is resolved when the used storage capacity for the first storage unit does not exceed the first threshold.

39. The system of claim 35 wherein the data processing system is configured to identify a storage unit from one or more storage units in the second group that is least full as the storage unit for storing the file.

40. The system of claim 35 wherein the data processing system is configured to:
generate a score for each storage unit in the second group; and
select a storage unit from the second group based upon the scores generated for the one or more storage units in the second group.

41. The system of claim 35 wherein the first storage unit stores a plurality of files and the data processing system is configured to:
generate a score for each file in the plurality of files stored on the first storage unit; and
select a file to be moved from the plurality of files based upon the scores generated for the files in the plurality of files.

42. The system of claim 35 wherein the first storage unit is assigned to a first server and the storage unit from the second group to which the file from the first storage unit is moved is assigned to a second server distinct from the first server.

43. A system comprising:
a plurality of storage units; and
a data processing system configured to manage the plurality of storage units, wherein the data processing system is configured to:
detect a condition associated with a first storage unit from the plurality of storage units;
identify a file stored on the first storage unit to be moved;
identify a storage unit from the plurality of storage units for storing the file, wherein the data storage cost associated with identified storage unit is lower than a data storage cost associated with the first storage unit; and
move the file from the first storage unit to the storage unit from the second group that has been identified for storing the file.

44. The system of claim 43 wherein the data processing system is configured to:
identify a set of storage units from the plurality of storage units that have an associated data storage cost that is lower than the data storage cost associated with the first storage unit; and
select a storage unit from the set of storage units for storing the file.

45. The system of claim 43 wherein the data processing system is configured to repeat, the identification of a file stored on the first storage unit to be moved, the identification of a storage unit from the plurality of storage units for storing the file, and the move of the file from the first storage unit to the storage unit from the second group that has been identified for storing the file, until the condition is resolved.

46. The system of claim 45 wherein the data processing system is configured to detect that used storage capacity for the first storage unit has exceeded a first threshold, and the condition is considered resolved when the used storage capacity for the first storage unit does not exceed the first threshold.

47. The system of claim 45 wherein the first storage unit stores a set of migrated files and a set of original files, the set of migrated files comprising files that have been migrated or remigrated from their original storage locations, the set of original files comprising files that have not been migrated from their original storage locations, and wherein a file from the set of original files is not selected to be moved until all files in the set of migrated files have been selected and moved from the first storage unit.

48. The system of claim 43 wherein the data processing system is configured to identify a storage unit from the plurality of storage units that is least full as the storage unit for storing the file.

49. The system of claim 43 wherein the data processing system is configured to:
generate scores for storage units in the plurality of storage units; and
select a storage unit from the plurality of storage units based upon the generated scores.

50. The system of claim 43 wherein the first storage unit stores a plurality of files and the data processing system is configured to:
generate a score for each file in the plurality of files stored on the first storage unit; and
select a file to be moved from the plurality of files based upon the scores generated for the files in the plurality of files.

51. The system of claim 43 wherein the first storage unit is assigned to a first server and the storage unit from the plurality of storage units to which the file from the first storage unit is moved is assigned to a second server distinct from the first server.

52. A system for managing a storage environment comprising a plurality of storage units, the system comprising:
means for detecting a condition associated with a first storage unit from the plurality of storage units;
means for determining a first group from a plurality of groups to which the first storage unit belongs, wherein each group comprises one or more storage units from the plurality of storage units and inclusion of a storage unit in a group depends on a cost of storing data on the storage unit;
means for identifying a second group from the plurality of groups having an associated data storage cost that is lower than a data storage cost associated with the first group;
means for identifying a file stored on the first storage unit to be moved;
means for identifying a storage unit from the second group for storing the file; and
means for moving the identified file from the first storage unit to the storage unit from the second group that has been identified for storing the file.

53. A system for managing a storage environment comprising a plurality of storage units, the system comprising:
means for detecting a condition associated with a first storage unit from the plurality of storage units;
means for identifying a file stored on the first storage unit to be moved;
means for identifying a storage unit from the plurality of storage units for storing the identified file, wherein the data storage cost associated with identified storage unit is lower than a data storage cost associated with the first storage unit; and
means for moving the identified file from the first storage unit to the storage unit from the second group that has been identified for storing the file.
